(19) United States
(12) Patent Application Publication
(10) Pub. No.: US 2024/0309523 A1
(43) Pub. Date: Sep. 19, 2024

(54) ELECTRODE, MEMBRANE ELECTRODE ASSEMBLY, ELECTROCHEMICAL CELL, STACK, AND ELECTROLYZER

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventors: Norihiro YOSHINAGA, Yokohama Kanagawa (JP); Mutsuki YAMAZAKI, Kawasaki Kanagawa (JP); Keisuke SHIINO, Kawasaki Kanagawa (JP); Taishi FUKAZAWA, Chofu Tokyo (JP); Yoshihiko NAKANO, Yokohama Kanagawa (JP); Koji MIZUGUCHI, Kawasaki Kanagawa (JP); Yoshitsune SUGANO, Kawasaki Kanagawa (JP); Masahiko YOSHIKI, Yokohama Kanagawa (JP); Asato KONDO, Yokohama Kanagawa (JP); Mitsuhiro OKI, Kawasaki Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 18/419,283

(22) Filed: Jan. 22, 2024

(30) Foreign Application Priority Data
Mar. 17, 2023 (JP) 2023-043637
Jan. 12, 2024 (JP) 2024-003033

(51) Int. Cl. C25B 11/053; C25B 9/23; C25B 9/77; C25B 11/031; C25B 11/056; C25B 11/063; C25B 11/093

(52) U.S. Cl. CPC C25B 11/053; C25B 9/23; C25B 9/77; C25B 11/031; C25B 11/056; C25B 11/063; C25B 11/093

(57) ABSTRACT

An electrode of an embodiment includes a porous titanium support and a catalyst layer for electrolysis provided on the porous titanium support and stacked sheet layers and gap layers alternately. A first covering layer including titanium oxide is provided on the porous titanium support on the catalyst layer side. A second covering layer including titanium oxide is provided on the porous titanium support on an opposite side of the catalyst layer. An average thickness of the first covering layer is denoted as D1. An average thickness of the second covering layer is denoted as D2. D1 and D2 satisfies 1 [nm]≤D2−D1≤20 [nm].

### CROSS-REFERENCE TO RELATED APPLICATION

This application is based upon and claims the benefit of priority from Japanese Patent Applications No. 2023-043637, the Filing Date of which is Mar. 17, 2023 and No. 2024-003033, the Filing Date of which is Jan. 12, 2024, the entire contents of which are incorporated herein by reference.

### FIELD

The present embodiments relate to an electrode, a membrane electrode assembly, an electrochemical cell, a stack, and an electrolyzer.

### BACKGROUND

In recent years, electrochemical cells have been actively studied. Among electrochemical cells, for example, a polymer electrolyte electrolysis cell (PEMEC) is expected to be used for hydrogen generation in a large-scale energy storage system. In order to ensure sufficient durability and electrolytic properties, platinum (Pt) nanoparticle catalysts are generally used for PEMEC cathode, and noble metal catalysts such as iridium (Ir) nanoparticle catalysts are used for PEMEC anode. Additionally, a method for obtaining hydrogen from ammonia is also considered. In addition, a method for obtaining organic material or carbon monoxide by electrolysis of carbon dioxide is also considered.

### BRIEF DESCRIPTION OF THE DRAWINGS

FIG. 1 is a schematic diagram of an electrode according to an embodiment;

FIG. 2 is a schematic cross-sectional diagram of a catalyst layer according to an embodiment;

FIG. 3 shows analysis spots according to an embodiment;

FIG. 4 is a graph according to an embodiment;

FIG. 5 is a cross-sectional image of an electrode 100;

FIG. 6 is a cross-sectional image of an electrode 100;

FIG. 7 is a cross-sectional image of an electrode 100;

FIG. 8 is a cross-sectional image of an electrode 100;

FIG. 9 is a schematic diagram of a membrane electrode assembly according to an embodiment;

FIG. 10 is a schematic diagram of an electrochemical cell according to an embodiment;

FIG. 11 is a schematic diagram of a stack according to an embodiment;

FIG. 12 is a schematic diagram of an electrolyzer according to an embodiment.

### DETAILED DESCRIPTION

An electrode of an embodiment includes a porous titanium support and a catalyst layer for electrolysis provided on the porous titanium support and stacked sheet layers and gap layers alternately. A first covering layer including titanium oxide is provided on the porous titanium support on the catalyst layer side. A second covering layer including titanium oxide is provided on the porous titanium support on an opposite side of the catalyst layer. An average thickness of the first covering layer is denoted as D1. An average thickness of the second covering layer is denoted as D2. D1 and D2 satisfies 1 [nm]≤D2−D1≤20 [nm].

Hereinafter, the embodiments will be described in detail with reference to the drawings.

It is to be noted that the same reference numerals are given to common components throughout the embodiments, and redundant explanations are omitted.

In the specification, values at 25 [° C.] and 1 atm (atmosphere) are shown. Each thickness of the members represents an average of distance in a stacking direction.

### First Embodiment

A first embodiment relates to an electrode. A schematic cross-sectional diagram of an electrode 100 according to an embodiment is shown in FIG. 1. The electrode 100 includes a support 1 and a catalyst layer 2.

The catalyst layer 2 according to the embodiment is used as a catalyst for electrolysis. A reaction of electrolysis is, for example, generating hydrogen from water or ammonia. A reaction of electrolysis is, for example, generating carbon mono-oxide from carbon dioxide. The catalyst layer 2 can be also used as an anode catalyst for electrolysis generation of ammonia.

The electrode 100 according to the first embodiment is used as an anode for water electrolysis. When the catalyst layer 2 further includes a catalyst for a fuel cell, the electrode 100 can be also used as an oxygen electrode of a fuel cell. The electrode 100 according to embodiments can be used as an anode for producing ammonia by electrolysis. The electrode 100 according to embodiments can be used as an anode of an electrolyzer for synthesizing ammonia. Hereinafter, an example of water electrolysis is described in the first embodiment and the other embodiments.

The electrode 100 according to embodiments can be also used for other than water electrolysis, for example, as an anode of a membrane electrode assembly for electrolysis of synthesizing ammonia so that ultrapure water is supplied to an anode, proton and oxygen is produced in the anode by decomposing water, the produced proton passes through an electrolyte membrane, and ammonia is synthesized by bonding nitrogen provided to a cathode, protons, and electrons. The electrode 100 according to embodiments can be also used as a cathode for producing hydrogen by electrolyzing ammonia. The electrode 100 according to embodiments can be used as a cathode for a hydrogen generation apparatus. Hereinafter, an example of water electrolysis is described in the first embodiment and the other embodiments. The electrode 100 according to embodiments can be also used for other than water electrolysis, for example, as a cathode of a membrane electrode assembly for electrolysis of decomposing ammonia so that ammonia is supplied to a cathode, proton and nitrogen is produced in the cathode by decomposing ammonia, the produced proton passes through an electrolyte membrane, and hydrogen is synthesized by bonding protons and electrons.

A material having porous and high electric conductivity is preferably used for the support 1. The support 1 is, for example, a porous member in which gas and liquid passes. The support 1 is preferably a titanium support because the electrode 100 is uses as an anode of a water electrolysis cell.

It is preferable that bulb metal used for the support 1 is Ti which has high durability. For example, a Ti mesh or a Ti cloth made of titanium fibers (non-woven cloth) is used for the support 1.

When movability of materials is considered, a porosity rate of the support 1 is preferably 20 [%] or more and 95 [%] or less and more preferably 40 [%] or more and 90 [%] or less.

When, for example, a metal non-woven cloth with intertwined titanium fibers is used as the support 1, a diameter of the fibers of the support 1 is preferably 1 [μm] or more and 500 [μm] or less. In view of reactivity and supplying electricity, the diameter of the fibers of the support 1 is more preferably 1 [μm] or more and 100 [μm] or less. When the support 1 is sintered particles, particle diameters of the sintered particles are preferably 1 [μm] or more and 500 [μm] or less. In view of reactivity and supplying electricity, the particle diameters of the sintered particles are preferably 1 [μm] or more and 500 [μm] or less.

A first covering layer 1A including titanium oxide is provided on the catalyst layer 2 side of the support 1. A second covering layer 1B including titanium oxide is also provided on the opposite side of the catalyst layer 2 of the support 1.

The case in which the support 1 is a Ti mesh will be described. The first covering layer 1A, which is an oxidized covering layer, is provided on the surface of the support 1 on the side where the catalyst layer 2 is provided. The second covering layer 1B, which is an oxidized covering layer, is provided on the surface of the support 1 opposite the side on which the catalyst layer 2 is provided. For example, the oxidized covering layer on the surface of the side on which the catalyst layer 2 of the Ti mesh or Ti cloth made of the Ti fibers is provided is the first covering layer 1A. For example, the oxidized covering layer on the surface opposite to the side on which the catalyst layer 2 of the Ti mesh or the Ti cloth made of the Ti fibers is provided is the second covering layer 1B.

The case in which the support 1 is a Ti cloth made of Ti fibers will be described. The first covering layer 1A, which is an oxidized covering layer, is provided on the surface of the Ti fibers on the side of the catalyst layer 2 of the support 1. The second covering layer 1B, which is an oxide layer, is provided on the surface of the Ti fiber on the opposite side of the support 1 from the side on which the catalyst layer 2 is provided. In this case, the first covering layer 1A is provided tubularly on the surface of the Ti fibers. It is preferred that the first covering layer 1A is provided on the entire surface of the Ti fibers on the catalyst layer 2 side. In this case, the second covering layer 1B is provided tubularly on the surface of the Ti fibers. It is preferred that the second covering layer 1B is provided entirely on the surface of the Ti fibers on the opposite side of the catalyst layer 2. When the oxidized covering is provided on the surface of the Ti fiber, the central portion of the Ti fiber (the inner region of the first covering layer 1A and the inner region of the second covering layer 1B) is Ti.

At least a portion of the first covering layer 1A is preferably in direct contact with the catalyst layer 2. The first covering layer 1A is preferably in direct contact with the Ti existing inside the first covering layer 1A and is in direct contact with the catalyst layer 2.

The second covering layer 1B is not in direct contact with the catalyst layer 2.

An average thickness of the first covering layer 1A is 10 [nm] or more and 50 [nm] or less. An oxidized covering layer whose thickness is thin may be formed on a surface of Ti due to natural oxidation. An average thickness of an oxidized covering layer due to unintentional oxidation is less than 10 [nm]. An average thickness of the first covering layer 1A is preferably 10 [nm] or more and 45 [nm] or less, and more preferably 20 [nm] or more and 40 [nm] or less.

An average thickness of the second covering layer 1B is 10 [nm] or more and 50 [nm] or less. An oxidized covering layer whose thickness is thin may be formed on a surface of Ti due to natural oxidation. An average thickness of an oxidized covering layer due to unintentional oxidation is 10 [nm] or less. An average thickness of the second covering layer 1B is preferably 10 [nm] or more and 45 [nm] or less, and more preferably 20 [nm] or more and 40 [nm] or less. The average thickness of the second covering layer 1B is thinner than the average thickness of the first covering layer 1A. In other words, the average thickness of the first covering layer 1A is thicker than the average thickness of the second covering layer 1B.

The surface of the side of the support 1 on which the catalyst layer 2 is provided is difficult to see due to the catalyst layer 2. The surface on the opposite side of the support 1 from the side on which the catalyst layer 2 is provided is visible on the electrode 100 alone. The support 1 on the side where the second covering layer 1B is provided is preferably yellow (yellowish color) with a glossy surface. The surface on the back side opposite the catalyst layer 2 side is preferably yellow with a metallic luster. The color of the surface of titanium varies with the thickness of the oxide layer. The surface on which the second covering layer 1B with an average thickness of 10 [nm] or more or less than 50 [nm] is provided is yellow.

By virtue of the first covering layer 1A and the second covering layer 1B provided on the support 1, it is preferable that durability of the electrode 100 is improved.

The average thickness of the first covering layer 1A is denoted as D1. The average thickness of the second covering layer 1B is denoted as D2. D1 and D2 preferably satisfy D2≥D1. By satisfying this relationship, it is preferable that the electrode 100 has high initial characteristics and high durability.

D1 and D2 is more preferably to satisfy 1 [nm]≤D2−D1≤20 [nm]. D1 and D2 is more preferably to satisfy 1 [nm]≤D2−D1≤10 [nm]. When the difference between the average thickness of the first covering layer 1A and the average thickness of the second covering layer 1B is large, the oxide layer may become locally thicker. When the thickness of the oxidized covering layer is thick, the electrical resistance of the support 1 tends to increase. Therefore, it is preferable that the electrode 100 that satisfies these relationships.

From the viewpoint of reducing degradation of the electrode 100 during operation, D1 and D2 preferably satisfy 1 [nm]≤D2−D1≤20 [nm] or 1 [nm]≤D2−D1≤10 [nm], and the average thickness D1 of the first covering layer 1A is preferably 1 [nm] or more and 50 [nm] or less. The average thickness D2 of the second covering layer 1B is preferably within the range satisfy 1 [nm]≤D2−D1≤20 [nm] (or 1 [nm]≤D2−D1≤10 [nm]) and 10 [nm]≤D1≤50 [nm].

From the viewpoint of reducing degradation of the electrode 100 during operation, when D1 and D2 satisfy 1 [nm]≤D2−D1≤20 [nm] or 1 [nm]≤D2−D1≤10 [nm], the average thickness D1 of the first covering layer 1A is preferably 5 [nm] or more and less than 100 [nm], more preferably 5 [nm] or more and 50 [nm] or less, and still more preferably 10 [nm] or more and 45 [nm] or less. The average thickness D2 of second covering layer 1B is preferably within the range satisfying 1 [nm]≤D2−D1≤20 [nm] (or 1 [nm]≤D2−D1≤10 [nm]) and 10 [nm]≤D1≤50 [nm].

From the viewpoint of reducing degradation of the electrode 100 during operation, when D1 and D2 satisfy 1 [nm]≤D2−D1≤20 [nm] or 1 [nm]≤D2−D1≤10 [nm], the average thickness D2 of the second covering layer 1B is preferably 6 [nm] or more and less than 100 [nm], more preferably 6 [nm] or more and 50 [nm] or less, and still more preferably 6 [nm] or more and 45 [nm] or less. From the viewpoint of suppressing degradation of the electrode 100 during operation, it is more preferable that D1 and D2 satisfy 3 [nm]≤D2−D1≤20 [nm]. It is more preferable that D1 and D2 satisfy 3 [nm]≤D2−D1≤10 [nm]. The average thickness D2 of the second covering layer 1B is preferably within the range satisfying 3 [nm]≤D2−D1≤20 [nm] (or 3 [nm]≤D2−D1≤10 [nm]) and 10 [nm]≤D1≤50 [nm].

From the viewpoint of reducing degradation of the electrode 100 during operation, when D1 and D2 satisfy 3 [nm]≤D2−D1≤20 [nm] or 3 [nm]≤D2−D1≤10 [nm], the average thickness D1 of the first covering layer 1A is preferably 5 [nm] or more and less than 100 [nm], more preferably, 5 [nm] or more and 50 [nm] or less, and still more preferably 5 [nm] or more and 45 [nm] or less.

From the viewpoint of reducing degradation of the electrode 100 during operation, when D1 and D2 satisfy 3 [nm]≤D2−D1≤20 [nm], the average thickness of the second covering layer 1B is preferably 8 [nm] or more and less than 100 [nm], more preferably 8 [nm] or more and 50 [nm] or less, still more preferably 8 [nm] or more and 45 [nm] or less.

90 [wt %] or more and 100 [wt %] or less of the first covering layer 1A is preferably TiO₂. 90 [wt %] or more and 100 [wt %] or less of the second covering layer 1B is preferably TiO₂. The oxidized covering layer on the surface of the support 1 preferably an oxide layer formed by oxidation of Ti, rather than an oxide layer that clearly contains other metallic elements. Therefore, it is more preferably that 95 [wt %] or more and 100 [wt %] or less of the first covering layer 1A is TiO₂. It is more preferably that 95 [wt %] or more and 100 [wt %] or less of the second covering layer 1B is TiO₂. It is more preferable that 98 [wt %] or more and 100 [wt %] or less of the first covering layer 1A is TiO₂. It is more preferable that 98 [wt %] or more and 100 [wt %] or less of the second covering layer 1B is TiO₂.

From the same viewpoint as above, it is preferable that 95 [atom %] or more and 100 [atom %] or less of the metallic element contained in the first covering layer 1A is Ti. From the same viewpoint as above, it is preferable that 95 [atom %] or more and 100 [atom %] or less of the metallic element contained in the second covering layer 1B is Ti.

From the same viewpoint as above, it is preferable that 99 [atom %] or more and 100 [atom %] or less of the metallic element contained in the first covering layer 1A is Ti. From the same viewpoint as above, it is preferable that 99 [atom %] or more and 100 [atom %] or less of the metallic element contained in the second covering layer 1B is Ti.

It is preferable that Ti is contained in a region excluding the oxide layer including the first region (first covering layer) 1A on the surface of the support 1 and the second region (second covering layer) 1B on the surface of the support 1 (the region excluding the oxide layer also including an inner region of the first region (the first covering layer) 1A and an inner region of the second region (the second covering layer) 1B). The inner region of the first covering layer 1A preferably includes Ti. The inner region of the second covering layer 1B preferably includes Ti. In the area excluding the oxide layer on the surface of the support 1, 95 [wt %] or more and 100 [wt %] or less is preferably Ti. In the area excluding the oxide layer on the surface of the support 1, 98 [wt %] or more and 100 [wt %] or less is preferably Ti. In the area excluding the oxide layer on the surface of the support 1, 99 [wt %] or more and 100 [wt %] or less is preferably Ti.

The thickness of the inner region of the first covering layer 1A is preferably 980 [nm] or more and 50 [μm] (50000 nm) or less. The thickness of the inner region of the first covering layer 1A is preferably 19.6 times or more and 5000 times or less of the thickness of the first covering layer 1A. It is preferable that the region of Ti where the oxide layer is not provided is relatively thicker.

The thickness of the inner region of the second covering layer 1B is preferably 980 [nm] or more and 50 [μm] (50000 nm) or less. The thickness of the inner region of the second covering layer 1B is preferably 19.6 times or more and 5000 times or less of the thickness of the second covering layer 1B. It is preferable that the region of Ti where the oxide film is not provided is thick.

The catalyst layer 2 contains noble metal oxides and non-noble metal oxides, with Ir and Ru as the main components. An intermediate layer, not shown, may be provided between the catalyst layer 2 and the support 1. A configuration in which the catalyst layer 2 and the support 1 are in direct contact with each other is preferable.

The amount of noble metal in catalyst layer 2 is preferably 0.02 [mg/cm²] or more and 1.0 [mg/cm²] or less, and more preferably 0.05 [mg/cm²] or more and 0.5 [mg/cm²] or less. The sum of the mass can be measured by ICP-MS.

The porosity ratio of the catalyst layer 2 is preferably 10 [%] or more and 90 [%] or less, and more preferably 30 [%] or more and 70 [%] or less.

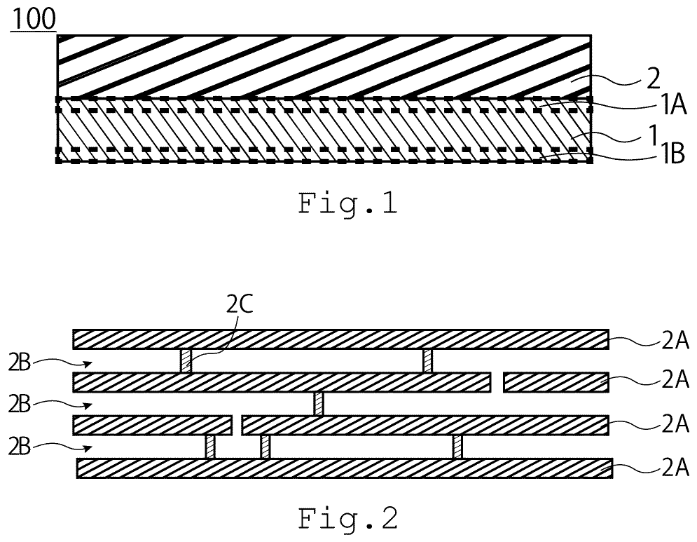

The catalyst layer 2 has a structure of alternately stacked sheet layers 2A and gap layers 2B. The stacking structure of catalyst layer 2 is shown in the schematic cross-sectional diagram of catalyst layer 2 in FIG. 2. The sheet layers 2A and gap layers 2B are stacked approximately in parallel. The gap layer 2B is mostly hollow, but some of the sheet layer 2A protrudes and the sheet layer 2A is connected to another sheet layer 2A. The sheet layer 2A is connected by columnar units 2C that exist in the gap layer 2B, which maintains the laminated structure.

The sheet layer 2A is a layer of catalyst particles, which are non-supported noble metal oxide particles which are aggregated in sheet form. There are some voids in the sheet layer 2A. The sheet layer 2A is a dense layer containing many catalyst particles.

The gap layer 2B is a region between the sheet layers 2A and contains catalyst particles, which are non-supported noble metal oxide particles. Unlike the sheet layer 2A, the gap layer 2B does not have a regular structure of the catalyst particles. The gap layer 2B is a region with a low density of the catalyst particles.

An average thickness of one layer of the sheet layers 2A is preferably 6 [nm] or more and 50 [nm] or less. An average thickness of one layer of the gap layers 2B is preferably 6 [nm] or more and 50 [nm] or less. The average thickness of one layer of the sheet layers 2A is preferably thicker than the average thickness of one layer of the gap layers 2B. Part of the gap layers 2B may be thicker than the thickness of part of the sheet layers 2A.

The catalyst layer 2 preferably includes Ir oxide or/and Ir and Ru composite oxide as the noble metal oxide, and optionally includes Ru oxide. The sum of the concentrations of Ir and Ru among the noble metals in the catalyst layer 2 is preferably 90 [wt %] or more and 100 [wt %] or less. The noble metals in the noble metal oxide of catalyst layer 2 are not limited to Ir and Ru. It may be possible to substitute other metals or alloys for Ru.

The catalyst layer 2 preferably includes one or more non-noble metal oxides selected from the group consisting of Ni, Co, and Mn as non-noble metal oxides. The non-noble metals included in the catalyst layer 2 preferably include Ni and optionally Co or/and Mn. When the amount of non-noble metals included in catalyst layer 2 is denoted as 100 [wt %], the total ratio of Ni, Co and Mn among the non-noble metals included in catalyst layer 2 is preferably 80 [wt %] or more and 100 [wt %] or less.

The catalyst layer 2 may include one or more non-noble metals selected from the group consisting of Ni, Co, and Mn.

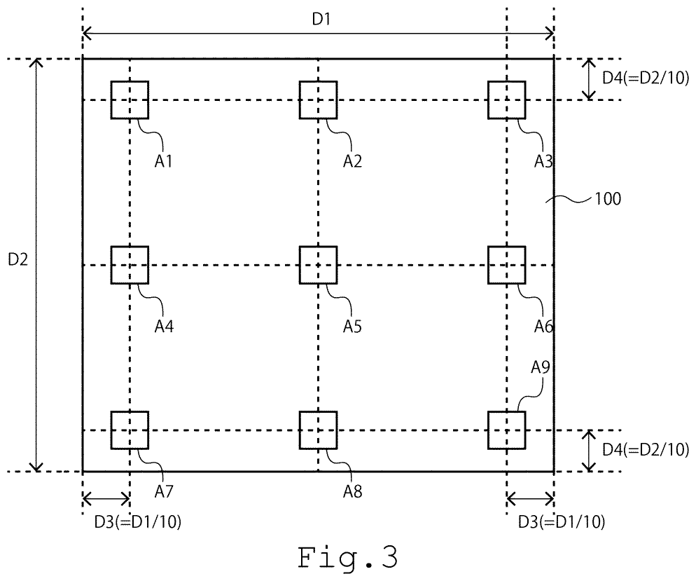

Each spot is square-shaped and has an area of at least 1 mm². Then, as shown in FIG. 3, if the length of the electrode 100 is defined as D1 and the width of the electrode 100 is defined as D2 (D1≥D2), a virtual line is drawn respectively inward at a distance of D3 (=D1/10) from the two opposing sides of the electrode 100 in the width direction, a virtual line is drawn respectively inward at a distance of D4 (=D2/10) inward from the two opposite sides in the length direction of the electrode 100, and then draw a virtual line parallel to the width direction through the center of the electrode 100 and a virtual line parallel to the length direction through the center of the electrode 100. Each area centered at the nine intersection points of the virtual lines is denoted as analysis spots A1 to A9. The cross-section observed by SEM is perpendicular to the plane of FIG. 3 and parallel to the width direction. The thickness of each gap layer 2B in the analysis spots A1 to A9 is determined at intervals of 50 [nm] in the width direction of the SEM image. Then, determine the percentage of the gap layer 2B where the thickness of the gap layer 2B is less than 2 [nm]. The average thicknesses of the gap layers 2B and the average thickness of the sheet layers 2A are obtained in the same manner. A similar analysis using the same SEM-EDX can be used to observe the cross-section of the support 1. By observing the cross-section of the support 1, the thickness of the oxide covering layer of the support 1 and the composition of the support 1 can be obtained.

The catalyst layer 2 is formed on the support 1 by sputtering alternately and repeatedly a sheet layer precursor which is a precursor of the sheet layer 2A and includes noble metal oxides and a gap layer precursor which is a precursor of the gap layer 2B and whose main component is non-noble metal oxide. The sheet layer precursor and the gap layer precursor are formed in an oxidizing atmosphere. Acid treatment such as sulfuric acid is used to elute the non-noble metal oxides. After eluting non-noble metals, heat treatment is performed in an oxidizing atmosphere. The heat treatment in an oxidizing atmosphere improves the adhesion between the catalyst layer 2 and the support 1.

For example, heating and anodic oxidation can be used to form a titanium dioxide covering layer with the desired thickness on any side of the support 1.

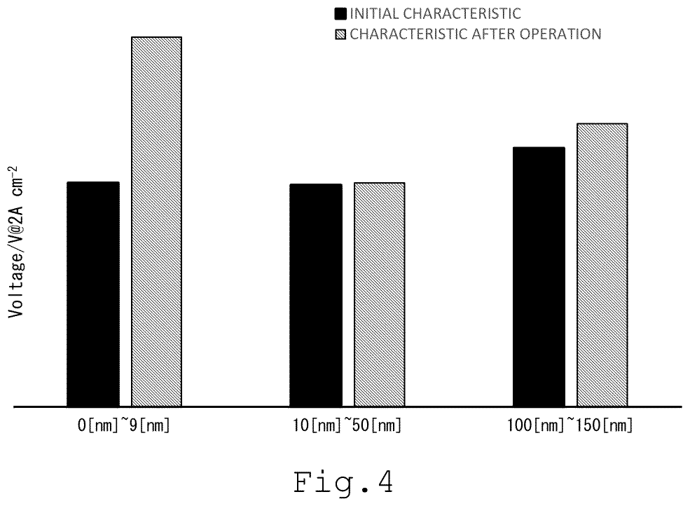

The average thickness of the oxidized covering layers (the first covering layer 1A and the second covering layer 1B) of the support 1, the initial characteristics, and the characteristics after operation will be described. Here, the initial characteristics and durability of the electrode 100 are explained using water electrolysis as an example. The electrode 100 is evaluated by fabricating an electrochemical cell using the electrode 100 as anode and cathode. Water electrolysis is performed by applying a current at a current density of 2 [A/cm-] between the anode and cathode using a power supply, and the cell voltage is compared at the start of operation and 75 hours after the start of operation. The vertical axis of FIG. 4 is the cell voltage. The values on the horizontal axis of FIG. 4 represent the average thickness of the oxidized covering layer (the first covering layer 1A and the second covering layer 1B) on the support 1. The thickness of the oxidized covering layer is adjusted by the oxidation conditions during the electrode 100 manufacturing process. The actual thickness of the oxidized covering layer is within the respective numerical value ranges shown on the horizontal axis.

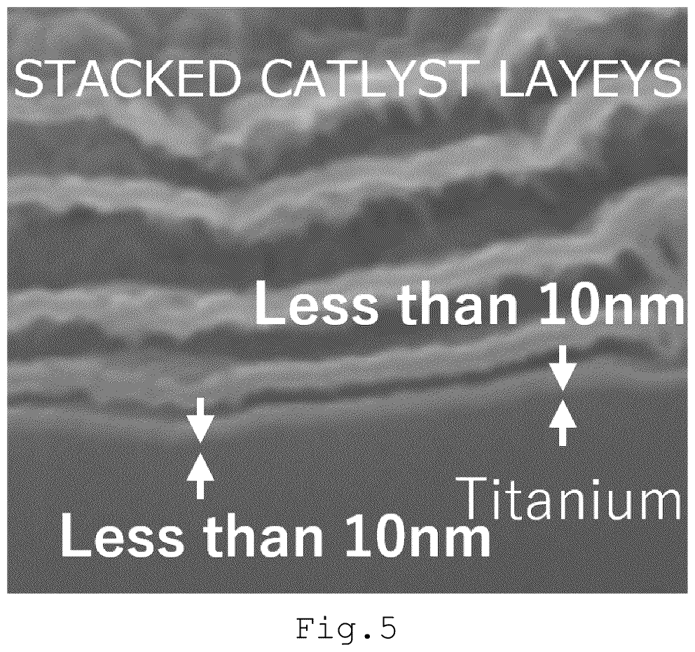

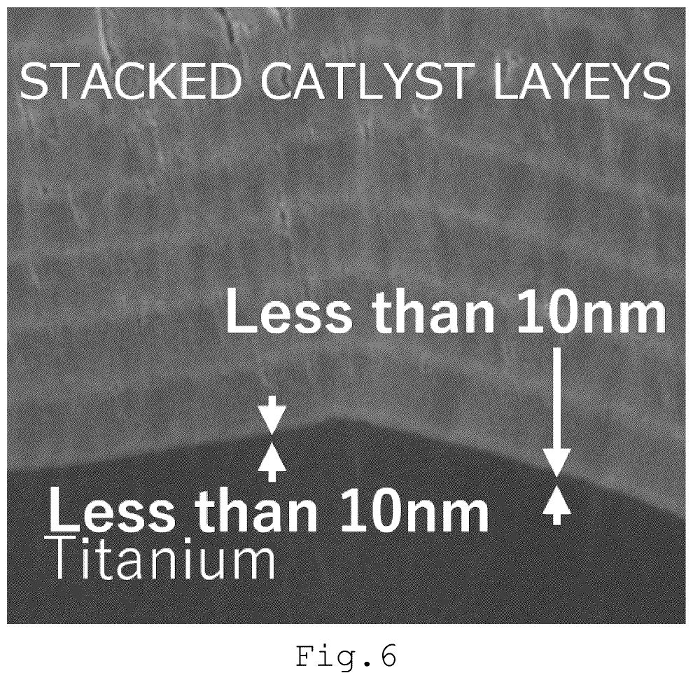

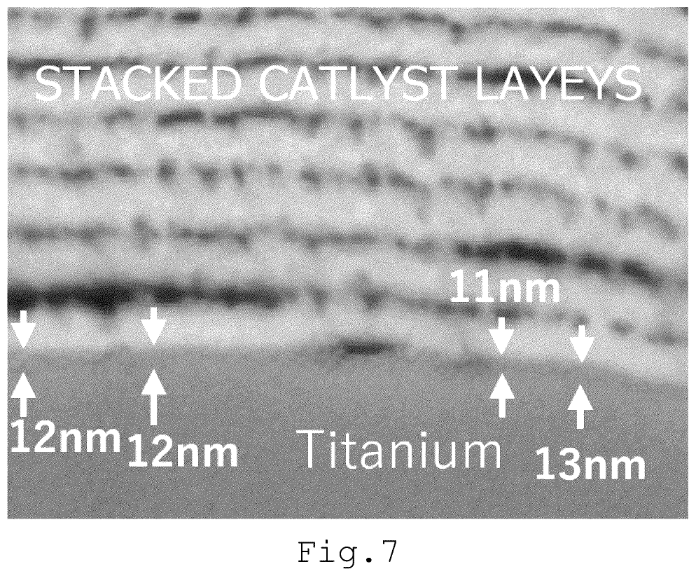

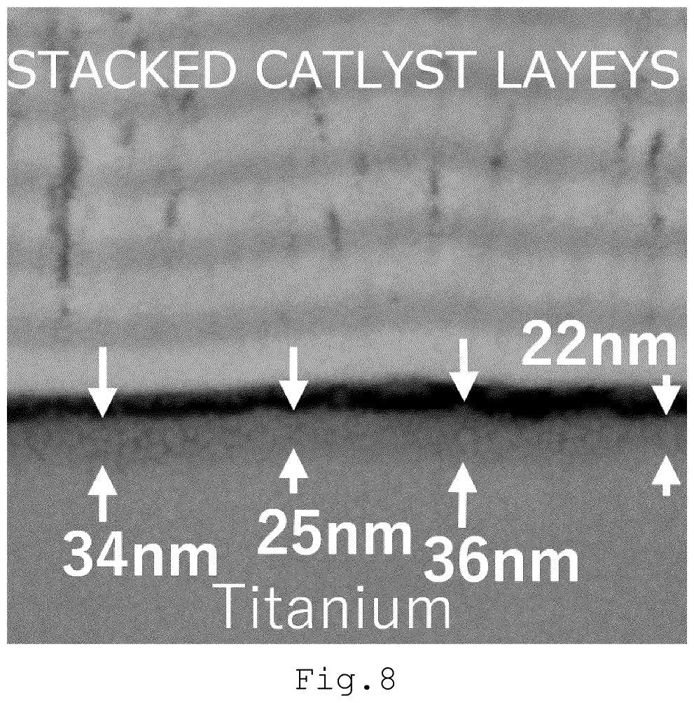

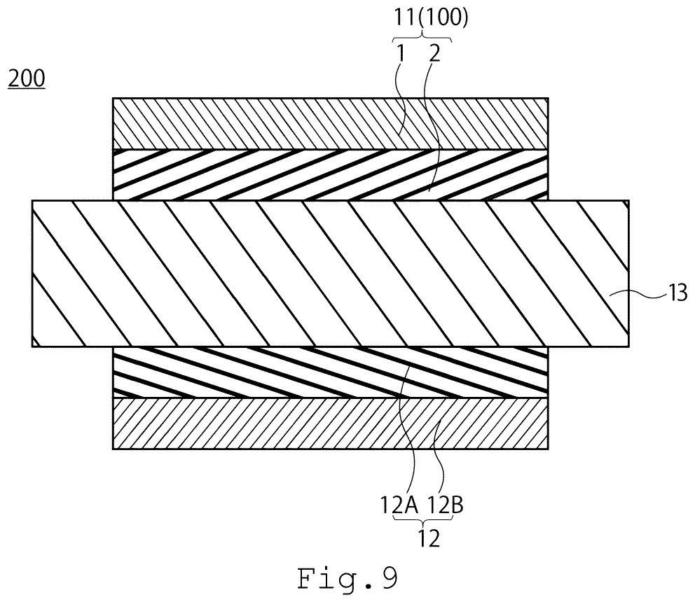

Cross-sectional diagrams of the electrode 100 showing the thickness of the first covering layer 1A are shown in FIGS. 5 to 8. FIGS. 5 to 8 show cross-sectional diagrams of the area where the stacked catalyst layers having a stacked structure are formed on the surface of titanium (support 1). FIG. 5 and FIG. 6 are cross-sectional diagrams of the electrode 100 corresponding to the Comparative Example. The first covering layer 1A is indistinct in FIG. 5 and FIG. 6. The thickness of the first covering layer 1A in FIGS. 5 and 6 is less than 10 [nm]. FIG. 7 and FIG. 8 are cross-sectional diagrams of the electrode 100 corresponding to the example. The first covering layer 1A in FIGS. 7 and 8 is a little more distinct than the first covering layer 1A in FIGS. 5 and 6. The thickness of the first covering layer 1A in FIG. 7 is 11 [nm] or more and 13 [nm] or less. The thickness of the first covering layer 1A in FIG. 8 is 22 [nm] or more and 36 [nm] or less.

FIG. 4 shows a graph showing the relationship between the thickness of the oxidized covering layer (the first covering layer 1A and the second covering layer 1B) on the support 1, the initial characteristics, and the characteristics after operation. When the average thickness of the oxidized covering layer is 0 [nm] or more and 10 [nm] or less, the initial cell voltage is low, but after operation, the cell voltage becomes higher, and the durability of the cell is not high. It is considered that the catalyst layer 2 has deteriorated due to the water electrolysis operation.

Compared to the case where the average thickness of the oxidized covering layer (the first covering layer 1A) is less than 1 [nm], the increase of the cell voltage after operation when D22≥D1 is satisfied and the average thickness of the oxidized covering layer (the first covering layer 1A) is 1 [nm] or more and 50 [nm] or less is reduced compared to the cell voltage where the average thickness of the oxidized covering layer (the first covering layer 1A) is 0 [nm]. Therefore, it is preferable that the average thickness of the oxidized covering layer (the first covering layer 1A) is 1 [nm] or more and 50 [nm] or less, and that 1 [nm]≤D2−D1≤20 [nm] is satisfied. The average thickness D2 of the second covering layer 1B is preferably within the range satisfying 1 [nm] ≤D2−D1≤20 [nm] and 10 [nm]≤D1≤50 [nm].

When the thickness of the oxidized covering layer is 10 [nm] or more and 50 [nm] or less, the initial cell voltage is low, and the cell voltage increases slightly after operation. The cell voltage e hardly rises due to water electrolysis operation, indicating that the electrode 100 of the embodiment is highly durable. When water electrolysis is performed using the electrode 100 of the embodiment, high water electrolysis characteristics can be maintained for a long time.

Compared to the case where the average thickness D1 of the first covering layer is less than 1 [nm], the increase in cell voltage after operation when the average thickness of the oxidized covering layer is more than 50 [nm] and less than 100 [nm] is reduced compared to the cell voltage where the average thickness of the oxidized covering layer is 0 [nm]. However, when the average thickness of the oxidized covering layer is more than 50 [nm] and less than 100 [nm], the initial voltage is slightly higher.

Degradation of the electrode 100 is suitably reduced even after operation longer than 75 hours (e.g., 750 hours). By virtue of using the electrode 100 satisfying 1 [nm]≤D2−D1≤20 [nm], the increase of the cell voltage can be reduced even when the operation time is long.

Degradation of the electrode 100 is suitably reduced even after operation longer than 75 hours (e.g., 750 hours). By virtue of using the electrode 100 satisfying 1 [nm]≤D2−D1≤10 [nm], the increase of the cell voltage can be reduced even when the operation time is long.

The increase of the cell voltage can be reduced even after operation longer than 75 hours (e.g., 750 hours) by using the electrode 100 where the average thickness D1 of the first covering layer 1A is 1 [nm] or more and 50 [nm] or less, D1 and D2 satisfies 1 [nm]≤D2−D1≤20 [nm] or less, and the average thickness D2 of the second covering layer 1B is within the range satisfying 1 [nm] ≤D2−D1≤20 [nm] and 10 [nm]≤D1≤50 [nm] (10 [nm]≤D1≤45 [nm] preferably).

The increase of the cell voltage can be reduced even after operation longer than 75 hours (e.g., 750 hours) by using the electrode 100 where the average thickness D1 of the first covering layer 1A is 3 [nm] or more and 50 [nm] or less, D1 and D2 satisfies 3 [nm]≤D2−D1≤20 [nm] or less, and the average thickness D2 of the second covering layer 1B is within the range satisfying 3 [nm] ≤D2−D1≤20 [nm] and 10 [nm]≤D1≤50 [nm] (10 [nm]≤D1≤45 [nm] preferably).

When the thickness of the oxidized covering layer is 100 [nm] or more, the cell voltage is high from the initial stage and slightly increases after operation. Although the increase in voltage due to water electrolysis operation is small, the cell voltage is high from the initial stage and the water electrolysis characteristics are low.

### Second Embodiment

A second embodiment relates to a membrane electrode assembly (MEA). A schematic cross-sectional diagram of a membrane electrode assembly 200 of an embodiment is shown in FIG. 9. The membrane electrode assembly 200 has a first electrode 11, a second electrode 12, and an electrolyte membrane 13. The first electrode 11 is preferably an anode electrode and the second electrode 12 is preferably a cathode electrode. It is preferred to use the electrode 100 of the first embodiment for the first electrode 11. The membrane electrode assembly 200 of the embodiment is preferably used in an electrochemical cell or stack for hydrogen generation or oxygen generation.

It is preferable to use the electrode 100 of the first embodiment for the first electrode 11. The catalyst layer 2 of the electrode 100 used as the first electrode 11 is provided on the electrolyte membrane 13 side. The catalyst layer 2 is preferably in direct contact with the electrolyte membrane 13.

The second electrode 12 includes a second support 12B and a second catalyst layer 12A. The second catalyst layer 12A is provided on the second support 12B. The second catalyst layer 12A is provided on the electrolyte membrane 13 side. The second catalyst layer 12A is preferably in direct contact with the electrolyte membrane 13.

It is preferable to use a porous and highly conductive material as the second support 12B. The second support 12B is a porous material through which gases and liquids pass. The second support 12B is, for example, a carbon paper or a metal mesh. As a metal mesh, a bulb metal porous support is preferred. It is preferable that the bulb metal porous support is a porous support including one or more metals selected from the group consisting of titanium, aluminum, tantalum, niobium, hafnium, zirconium, zinc, tungsten, bismuth, and antimony or one metal selected from the group consisting of titanium, aluminum, tantalum, niobium, hafnium, zirconium, zinc, tungsten, bismuth, and antimony. The second support 12B has a carbon layer (MPL layer) containing carbon particles and a water repellent resin (fluororesin such as PTFE or Nafion). The carbon layer is provided, for example, between the carbon paper and the second catalyst layer 12A.

The second catalyst layer 12A has a catalyst metal. The second catalyst layer 12A is preferably particles of catalyst metal and the catalyst metal is not supported on a carrier. The second catalyst layer 12A is preferably a porous catalyst layer. The catalyst metal is not limited, but includes, for example, one or more metals selected from the group consisting of Pt, Rh, Os, Ir, Pd, and Au. It is preferred to include one or more selected from the group consisting of such catalytic materials. The catalyst metal is preferably metal, alloy or metal oxide. The second catalyst layer 12A, for example, preferably has a plurality of catalyst units consisting of alternately stacked catalyst layers in sheet layers and gap layers.

The amount of metal per area of the second catalyst layer 12A is preferably 0.02 [mg/cm²] or more and 1.0 [mg/cm²] or less, and more preferably 0.05 [mg/cm²] or more and 0.5 [mg/cm²] or less. The sum of these masses can be measured by ICP-MS.

The porosity ratio of the second catalyst layer 12A is preferably 10 [%] or more and 90 [%] or less, and more preferably 30 [%] or more and 70 [%] or less.

The electrolyte membrane 13 is preferably a proton-conducting membrane. Fluorinated polymers or aromatic hydrocarbon polymers having one or more selected from the group consisting of sulfonic acid groups, sulfonimide groups, and sulfate groups are preferred as electrolyte membrane 13. Fluorinated polymers having sulfonic acid groups are preferred as electrolyte membranes 13. Fluorinated polymers having sulfonic acid groups include, for example, Nafion (trademark DuPont), Flemion (trademark Asahi Kasei), Selemion (trademark Asahi Kasei), Aquivion (trademark Solvay Specialty Polymers) or Aciplex (trademark Asahi Glass Co., Ltd.), etc. can be used. Various conductive membranes such as an anion exchange membrane and a porous membrane may be used in place of proton-conducting membranes.

The thickness of the electrolyte membrane 13 can be chosen according to permeability, durability, and other characteristics of the membrane. From the viewpoint of strength, dissolution resistance, and output power characteristics of the MEA, the thickness of the electrolyte membrane 13 is preferably 20 [μm] or more and 500 [μm] or less, more preferably 50 [μm] or more and 300 [μm] or less, and still more preferably 80 [μm] or more and 200 [μm] or less.

The electrolyte membrane 13 preferably includes a noble metal region on the first electrode 11 side. The noble metal region includes noble metal particles. The noble metal region is preferably located on the surface of the electrolyte membrane 13. The noble metal region preferably consists of a single region, but may also consist of multiple separated regions.

The noble metal particles are preferably particles of one or more noble metals selected from the group consisting of Pt, Re, Rh, Ir, Pd, and Ru. The noble metal particles may include particles of an alloy containing one or more selected from the group consisting of Pt, Re, Rh, Ir, Pd and Ru. The noble metal particles are preferably particles of one noble metal selected from the group consisting of Pt, Re, Rh, Ir, Pd, and Ru. Pt particles are preferred for the noble metal particles. Re particles are preferred for the noble metal particles. Rh particles are preferred for the noble metal particles. Ir particles are preferred for noble metal particles. Pd particles are preferred for noble metal particles. Ru particles are preferred for noble metal particles.

The noble metal particles oxidize hydrogen that is generated on the cathode side and passes through the electrolyte membrane 13. The noble metal particles can reduce hydrogen leakage. Since the noble metal particles are present on the anode side, the hydrogen discharged from the cathode side is less likely to be oxidized. The area where noble metal particles are present may also be present in the electrolyte membrane 13 on the second electrode 12 (cathode) side.

The average circumscribed circle diameter of the noble metal particles is preferably 0.5 [nm] or more and 50 [nm] or less, more preferably 1 [nm] and 10 [nm] is more preferably, and still more preferably 1 [nm] or more and 5 [nm] or less.

By virtue of using the highly durable electrode 100 as the anode of the membrane electrode assembly 200, the membrane electrode assembly 200 can be operated for a long time with high activity.

### Third Embodiment

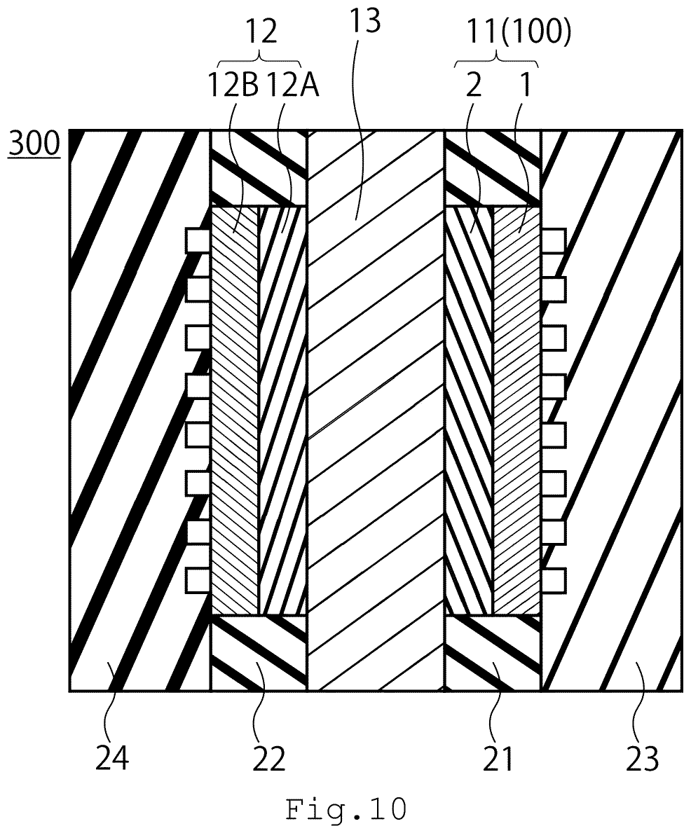

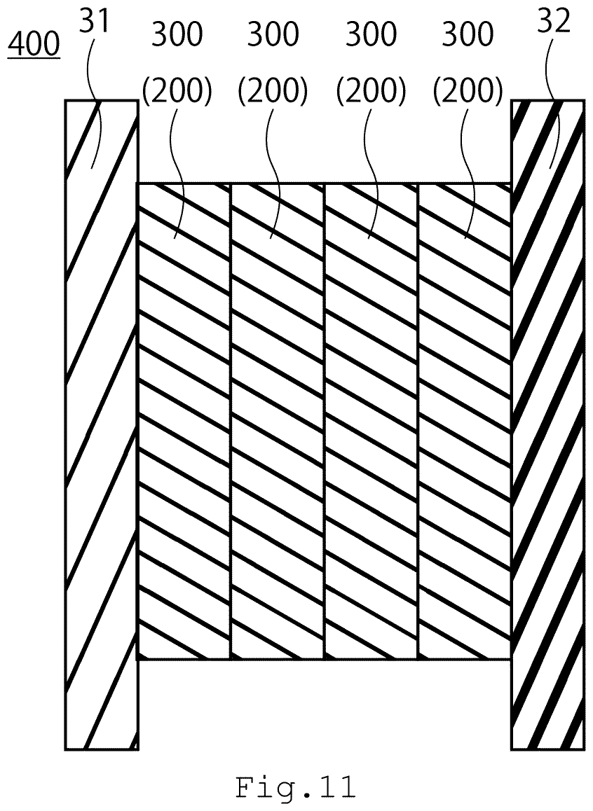

The third embodiment relates to an electrochemical cell. FIG. 10 shows a cross-sectional diagram of the electrochemical cell 300 of the third embodiment. The electrochemical cell 300 will be described below using water electrolysis as an example, but hydrogen can also be generated by decomposing ammonia and other substances other than water.

As shown in FIG. 10, the electrochemical cell 300 of the third embodiment includes a first electrode (anode) 11, a second electrode (cathode) 12, an electrolyte membrane 13, a gasket 21, a gasket 22, a separator 23, and a separator 24. As gasket 21, a seal member of the first electrode 11 may be used. As gasket 22, the seal member of the second electrode 12 may be used.

It is preferable to use a membrane electrode assembly 200 in which the first electrode (anode) 11, the second electrode (cathode) 12, and the electrolyte membrane 13 are bonded together. The anode feeder may be provided separately from the separator 23. The cathode feeder may be provided separately from the separator 24.

In the electrochemical cell 300 of FIG. 10, a power supply, not shown, is connected to the separator 23 and the separator 24, and reactions occur at the anode 11 and the cathode 12. Water, for example, is supplied to the anode 11, and at the anode 11, water is decomposed into protons, oxygen and electrons. The support member and the feeder of the electrode is a porous material, and this porous material acts as a flow channel plate. The produced and unreacted water is discharged, while the protons and electrons are used for cathodic reactions. In the cathode reaction, protons and electrons react to produce hydrogen. Either or both of the hydrogen and oxygen produced are used for example as fuel for fuel cells.

### Fourth Embodiment

A fourth embodiment relates to a stack. FIG. 11 is a schematic cross-sectional diagram of a stack 400 of the fourth embodiment. The fourth embodiment of the stack 400 shown in FIG. 11 includes a plurality of MEA 200 or electrochemical cells 300 connected in series, with fastening plates 31 and 32 attached to both ends of the MEA or electrochemical cells.

Since the amount of hydrogen produced by an electrochemical cell 300 consisting of a single MEA 200 is small, a stack 400 consisting of multiple MEA 200 or multiple electrochemical cells 300 connected in series can produce a large amount of hydrogen.

### Fifth Embodiment

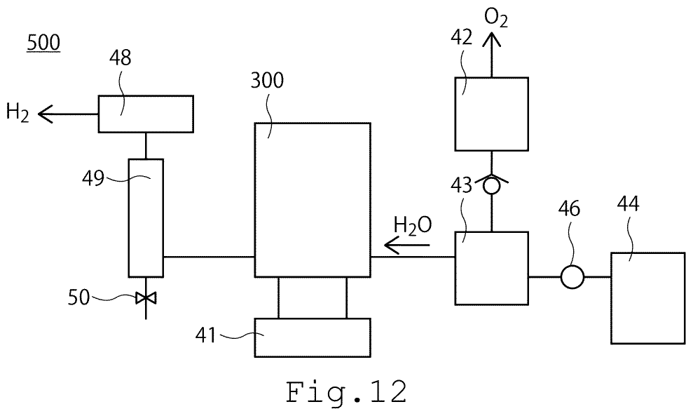

A fifth embodiment relates to an electrolyzer. FIG. 12 shows a conceptual diagram of the electrolyzer of the fifth embodiment. The electrolyzer 500 uses electrochemical cell 300 or stack 400. The electrolyzer 500 in FIG. 12 is for water electrolysis. The electrolyzer for water electrolysis will be described. For example, in the case of hydrogen generation from ammonia, it is preferable to employ an apparatus having different configuration with using the electrode 100. The electrodes of the embodiments can also be used in electrolyzer that electrolyze carbon dioxide to produce organic substances such as methanol and ethylene, and carbon monoxide.

As shown in FIG. 12, single cells for water electrolysis are stacked in series to form a stack 400. The stack 400 is equipped with a power supply 41 and voltage is applied between the anode and cathode. On the anode side of the stack 400, a gas-liquid separator 42 that separates the generated gas and unreacted water, and a mixing tank 43 are connected, the water is supplied to the mixing tank 43 from an ion-exchange water production unit 44 which supplies water by a pump 46, and the water is circulated to the anodes through the check valve 47 from the gas-liquid separator 42 mixed in the mixing tank 43. The oxygen produced at the anode passes through the gas-liquid separator 42, where oxygen gas is obtained. On the cathode side, a hydrogen purifier 49 is connected continuously to the gas-liquid separator 48 to obtain high-purity hydrogen. Impurities are discharged through a path with a valve 50 connected to the hydrogen purifier 49. The stack and mixing tank can be heated to control stable operating temperatures, and the current density during pyrolysis can be controlled.

In the specification, some of the elements are represented by elemental symbols only.

Hereinafter, clauses according to embodiments will be described. The configurations described in the clauses are preferable configurations using the electrode 100.

Configurations combined with components described in the clauses are also preferable configurations using electrode 100.

### Clause 1

An electrode comprising:
a porous titanium support; and
a catalyst layer for electrolysis provided on the porous titanium support and stacked sheet layers and gap layers alternately,
wherein a first covering layer including titanium oxide is provided on the porous titanium support on the catalyst layer side,
a second covering layer including titanium oxide is provided on the porous titanium support on an opposite side of the catalyst layer,
an average thickness of the first covering layer is denoted as D1,
an average thickness of the second covering layer is denoted as D2, and
D1 and D2 satisfies 1 [nm]≤D2−D1≤20 [nm].

### Clause 2

The electrode according to clause 1,
wherein D1 is 10 [nm] or more and 50 [nm] or less.

### Clause 3

The electrode according to clause 1 or 2,
wherein D2 is 10 [nm] or more and 50 [nm] or less, and
the porous (titanium) support on the side where the second covering layer is provided is yellow (or yellowish) with a glossy surface.

### Clause 4

The electrode according to any one of clauses 1 to 3,
wherein D1 and D2 are within a range satisfying 3 [nm]≤D2-D1≤20 [nm].

### Clause 5

The electrode according to any one of clauses 1 to 4,
D2 is within the range satisfying 1 [nm]≤D2−D1≤20 [nm] and 10 [nm]≤D1≤50 [nm].

### Clause 6

The electrode according to any one of clauses 1 to 5,
D1 and D2 satisfy 1 [nm]≤D2−D1≤20 [nm].

### Clause 7

The electrode according to any one of clauses 1 to 6,
D1 and D2 satisfy 1 [nm]≤D2−D1≤10 [nm],
D1 is 10 [nm] or more and 50 [nm] or less, and
D2 is within the range satisfying 1 [nm]≤D2−D1≤10 [nm] and 10 [nm]≤D1≤50 [nm].

### Clause 8

The electrode according to any one of clauses 1 to 7,
D1 and D2 satisfy 3 [nm]≤D2−D1≤10 [nm],
D1 is 10 [nm] or more and 50 [nm] or less, and
D2 is within the range satisfying 3 [nm]≤D2−D1≤10 [nm] and 10 [nm]≤D1≤50 [nm].

### Clause 9

The electrode according to any one of clauses 1 to 8,
D1 is 10 [nm] or more and 45 [nm] or less, and
D2 is within the range satisfying 1 [nm]≤D2−D1≤10 [nm] and 10 [nm]≤D1≤45 [nm].

### Clause 10

The electrode according to any one of clauses 1 to 9,
D1 is 10 [nm] or more and 45 [nm] or less, and
D2 is within the range satisfying 3 [nm]≤D2−D1≤10 [nm] and 10 [nm]≤D1≤45 [nm].

### Clause 11

The electrode according to any one of clauses 1 to 10,
wherein 90 [wt %] or more and 100 [wt %] or less of the first covering layer is TiO₂, and
90 [wt %] or more and 100 [wt %] or less of the second covering layer is TiO₂.

### Clause 12

The electrode according to any one of clauses 1 to 11,
wherein 95 [wt %] or more and 100 [wt %] or less of the first covering layer is TiO₂, and
95 [wt %] or more and 100 [wt %] or less of the second covering layer is TiO₂.

### Clause 13

The electrode according to any one of clauses 1 to 12,
wherein 95 [atom %] or more and 100 [atom %] or less of metallic element contained in the first covering layer is Ti, and 95 [atom %] or more and 100 [atom %] or less of metallic element contained in the second covering layer is Ti.

### Clause 14

The electrode according to any one of clauses 1 to 13,
wherein 99 [atom %] or more and 100 [atom %] or less of metallic element contained in the first covering layer is Ti, and
99 [atom %] or more and 100 [atom %] or less of metallic element contained in the second covering layer is Ti.

### Clause 15

The electrode according to any one of clauses 1 to 14, wherein an inner region of the first covering layer includes Ti,
a thickness of the inner region of the first covering layer is 980 [nm] or more and 50 [μm] or less,
an inner region of the second covering layer includes Ti, and
a thickness of the inner region of the second covering layer is 980 [nm] or more and 50 [μm] or less.

### Clause 16

The electrode according to any one of clauses 1 to 16,
wherein an inner region of the first covering layer includes Ti,
a thickness of the inner region of the first covering layer is 19.6 times or more and 5000 times or less of a thickness of the first covering layer,
an inner region of the second covering layer includes Ti, and
a thickness of the inner region of the second covering layer is 19.6 times or more and 5000 times or less of a thickness of the second covering layer.

### Clause 17

A membrane electrode assembly comprising:
the electrode according to any one of clauses 1 to 16.

### Clause 18

An electrochemical cell comprising:
the membrane electrode assembly according to clause 17.

### Clause 19

A stack comprising:
the electrode chemical cell according to clause 18.

### Clause 20

An electrolyzer comprising:
the electrochemical cell according to clause 19.

While certain embodiments have been described, these embodiments have been presented by way of example only, and are not intended to limit the scope of the inventions. Indeed, the novel embodiments described herein, for example, PEMEC as a water electrolysis cell may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. For, example, the color “Yellow” is can be replaced by the expression “yellowish color”.

What is claimed is:

1. An electrode comprising:
a porous titanium support; and
a catalyst layer for electrolysis provided on the porous titanium support and stacked sheet layers and gap layers alternately,
wherein a first covering layer including titanium oxide is provided on the porous titanium support on the catalyst layer side,
a second covering layer including titanium oxide is provided on the porous titanium support on an opposite side of the catalyst layer,
an average thickness of the first covering layer is denoted as D1,
an average thickness of the second covering layer is denoted as D2, and
D1 and D2 satisfies 1 [nm]≤D2−D1≤20 [nm].

2. The electrode according to claim 1,
wherein D1 is 10 [nm] or more and 50 [nm] or less.

3. The electrode according to claim 1,
wherein D2 is 10 [nm] or more and 50 [nm] or less, and
the porous titanium support on the side where the second covering layer is provided is yellow with a glossy surface.

4. The electrode according to claim 1,
wherein D1 and D2 are within a range satisfying 3 [nm]≤D2−D1≤20 [nm].

5. The electrode according to claim 1,
D1 and D2 are within a range satisfying 1 [nm]≤D2−D1≤20 [nm] and 10 [nm]≤D1≤50 [nm].

6. The electrode according to claim 1,
D1 and D2 satisfy 1 [nm]≤D2−D1≤20 [nm].

7. The electrode according to claim 1,
wherein 90 [wt %] or more and 100 [wt %] or less of the first covering layer is TiO₂, and
90 [wt %] or more and 100 [wt %] or less of the second covering layer is TiO₂.

8. The electrode according to claim 1,
wherein 95 [wt %] or more and 100 [wt %] or less of the first covering layer is TiO₂, and
95 [wt %] or more and 100 [wt %] or less of the second covering layer is TiO₂.

9. The electrode according to claim 1,
wherein 95 [atom %] or more and 100 [atom %] or less of metallic element contained in the first covering layer is Ti, and
95 [atom %] or more and 100 [atom %] or less of metallic element contained in the second covering layer is Ti.

10. The electrode according to claim 1,
wherein 99 [atom %] or more and 100 [atom %] or less of metallic element contained in the first covering layer is Ti, and
99 [atom %] or more and 100 [atom %] or less of metallic element contained in the second covering layer is Ti.

11. The electrode according to claim 1,
wherein an inner region of the first covering layer includes Ti,
a thickness of the inner region of the first covering layer is 980 [nm] or more and 50 [μm] or less,
an inner region of the second covering layer includes Ti, and
a thickness of the inner region of the second covering layer is 980 [nm] or more and 50 [μm] or less.

12. The electrode according to claim 1,
wherein an inner region of the first covering layer includes Ti,
a thickness of the inner region of the first covering layer is 19.6 times or more and 5000 times or less of a thickness of the first covering layer,
an inner region of the second covering layer includes Ti, and
a thickness of the inner region of the second covering layer is 19.6 times or more and 5000 times or less of a thickness of the second covering layer.

13. A membrane electrode assembly comprising:
the electrode according to claim 1.

14. An electrochemical cell comprising:
the membrane electrode assembly according to claim 13.

15. A stack comprising:
the electrode chemical cell according to claim 14.

16. An electrolyzer comprising:
the electrochemical cell according to claim 14.
